(19) United States
(12) Patent Application Publication
(10) Pub. No.: US 2024/0179557 A1
(43) Pub. Date: May 30, 2024

(54) METHOD AND APPARATUS FOR INFORMATION TRANSMISSION

(71) Applicant: BEIJING UNISOC COMMUNICATIONS TECHNOLOGY CO., LTD., Beijing (CN)

(72) Inventor: Hualei WANG, Beijing (CN)

(73) Assignee: BEIJING UNISOC COMMUNICATIONS TECHNOLOGY CO., LTD., Beijing (CN)

(21) Appl. No.: 18/551,883

(22) PCT Filed: Mar. 11, 2022
(86) PCT No.: PCT/CN2022/080383

§ 371 Date: Sep. 22, 2023

(30) Foreign Application Priority Data
Mar. 22, 2021 (CN) 202110304739.1

(51) Int. Cl. H04W 24/10

(52) U.S. Cl. CPC H04W 24/10

(57) ABSTRACT

A method and apparatus for information transmission are provided in the disclosure. The method includes: determining whether a first cell in which a beam failure event occurs exists in one or more cells; and reporting first indication information to a network device in response to existence of the first cell in which the beam failure event occurs. The first indication information indicates a type of a beam failure event that occurs in each cell in the first cell, and the type of a beam failure event comprises a transmission and reception point (TRP)-level beam failure event and/or a cell-level beam failure event. With the method, a terminal device is able to report a TRP-level beam failure event to a network device.

### CROSS-REFERENCE TO RELATED APPLICATION(S)

This application is a National Stage of International Application No. PCT/CN2022/080383, field Mar. 11, 2022, which claims priority to Chinese Patent Application No. 2021103047391 filed Mar. 22, 2021, the entire disclosure of which are hereby incorporated by reference.

### TECHNICAL FIELD

This disclosure relates to the field of communication technologies, and in particular, to a method and apparatus for information transmission.

### BACKGROUND

In a 5th generation (5G) new radio (NR) system, network devices and terminal devices may perform transmission and reception of information with beams. Each beam corresponds to a reference signal (RS), and the terminal device can detect a corresponding beam according to the RS.

In the case where the terminal device moves or an antenna direction of the network device changes, beam failure may occur in a beam configured by the network device for the terminal device. The beam failure may be classified into transmission and reception point (TRP)-level beam failure and cell-level beam failure. At present, in response to detecting cell-level beam failure, the terminal device can report relevant information to the network device to indicate a cell in which the beam failure occurs. However, the terminal device is unable to report, to the network device, information indicating TRP-level beam failure.

### SUMMARY

In a first aspect, a method for information transmission is provided in embodiments of the disclosure. The method includes: determining whether a first cell in which a beam failure event occurs exists in one or more cells: and reporting first indication information to a network device in response to existence of the first cell in which the beam failure event occurs. The first indication information indicates a type of a beam failure event that occurs in each cell in the first cell, and the type of a beam failure event comprises a TRP-level beam failure event and/or a cell-level beam failure event.

In a second aspect, an apparatus for information transmission is provided in embodiments of the disclosure. The apparatus for information transmission includes a processor and a memory. The memory is configured to store a computer program. The computer program comprises program instructions. The processor is configured to invoke the program instructions to perform the method for information transmission in the first aspect.

In a third aspect, a non-transitory computer-readable storage medium is provided in embodiments of the disclosure. The computer-readable storage medium stores one or more instructions. A processor is configured to load the one or more instructions and perform the method for information transmission in the first aspect.

### BRIEF DESCRIPTION OF THE DRAWINGS

In order to describe technical solutions in embodiments of the disclosure more clearly, the following will give a brief introduction to accompanying drawings required for describing embodiments. Apparently, the accompanying drawings hereinafter described illustrate some embodiments of the disclosure. Based on these drawings, those of ordinary skills in the art can also obtain other drawings without creative effort.

FIG. 1 is a schematic diagram of a communication network architecture provided in embodiments of the disclosure.

FIG. 2 is a schematic flowchart illustrating a method for information transmission provided in embodiments of the disclosure.

FIG. 3 is a schematic diagram of two cells each configured with a TRP-level beam recovery process provided in embodiments of the disclosure.

FIG. 4 is a schematic flowchart illustrating another method for information transmission provided in embodiments of the disclosure.

FIG. 5 is a schematic flowchart illustrating yet another method for information transmission provided in embodiments of the disclosure.

FIG. 6 is a schematic flowchart illustrating yet another method for information transmission provided in embodiments of the disclosure.

FIG. 7 is a schematic diagram of units of an apparatus for information transmission provided in embodiments of the disclosure.

FIG. 8 is a simplified schematic structural view of an apparatus for information transmission provided in embodiments of the disclosure.

FIG. 9 is a simplified schematic diagram of a chip of an apparatus for information transmission provided in embodiments of the disclosure.

### DETAILED DESCRIPTION

Exemplary embodiments are described in detail herein, and examples of the exemplary embodiments are presented in accompanying drawings. When the following description relates to the accompanying drawings, unless otherwise stated, the same numbers in different accompanying drawings represent the same or similar element. Embodiments described in the following exemplary embodiments do not represent all embodiments consistent with the disclosure. On the contrary, they are merely examples of apparatuses and methods that are described in the appended claims in detail and that are consistent with some aspects of the disclosure.

It should be noted that in this specification, the terms “include”, “comprise”, “contain”, or any other variants thereof are intended to cover non-exclusive inclusion, such that a process, method, article, or apparatus including a series of elements not only includes those elements, but also includes other elements that are not explicitly listed, or elements inherent to the process, method, article, or apparatus. If there are no more restrictions, the element defined by the sentence “include a . . . ” does not exclude the existence of other same elements in the process, method, article, or apparatus that includes the element. In addition, components, features, and elements with the same name in different embodiments of the disclosure may have the same meaning or may have different meanings, the specific meaning thereof needs to be determined by the explanation in the specific embodiment or further combined with the context in the specific embodiment.

It should be understood that although the terms first, second, third, or the like, may be used herein to describe various information, the information should not be limited to these terms. These terms are only used to distinguish the same type of information from each other. For example, without departing from the scope of the disclosure, first information can also be referred to as second information, and similarly, the second information can also be referred to as the first information. Depending on the context, the word “if” as used herein can be interpreted as “when”, “while” or “in response to a determination”. In addition, as used herein, the singular forms “a”, “an”, and “the” are intended to also include the plural, unless the context dictates to the contrary. It should be further understood that the terms “include”, “comprise”, and “contain” indicate the presence of the described features, steps, operations, elements, assemblies, items, types, and/or groups, but do not exclude the existence, appearance, or addition of one or more other features, steps, operations, elements, assemblies, items, types, and/or groups. The terms “or” and “and/or”, etc., used herein are to be interpreted as inclusive or mean any one or any combination. Therefore, “A. B. or C” or “A. B. and/or C” means “any one of: A: B: C: A and B: A and C: B and C: A. B. and C”. An exception to this definition will only occur when the combination of elements, functions, steps, or operations is inherently mutually exclusive in some way.

It should be understood that, although steps in the flowchart of embodiment of the disclosure are displayed in sequence as indicated by arrows, the steps are not necessarily executed in sequence as indicated by the arrows. Unless specifically stated herein, the execution of these steps is not strictly limited by the order, and these steps may be executed in other orders. Furthermore, at least part of steps in the figures may include multiple sub-steps or multiple stages, and these sub-steps or stages are not necessarily executed at the same time, but can be executed at different times, and these sub-steps or stages are also not necessarily executed in sequence, and can be executed alternately with other steps or at least part of sub-steps or stages of the other steps.

It should be noted that step numbers such as 110 and 120 used herein aims to describe corresponding content more clearly and briefly, which do not constitute a substantive limitation to the sequence. Those persons skilled in the art may execute 120 first and then execute 110 and the like during specific embodiment, but these should be within the scope of protection of the disclosure.

In the subsequent illustration, the use of suffixes such as “module”, “component”, or “unit” for denoting elements is merely for facilitating illustration of the disclosure, and has no particular meaning per se. Thus, “module”, “component”, or “unit” may be used interchangeably.

In order to better understand embodiments of the disclosure, the following will introduce technical terms involved in embodiments of the disclosure.

Wave beam refers to a shape formed by electromagnetic waves emitted by an antenna, and the wave beam mainly includes a global beam, a spot beam, and a shaped beam.

A terminal may be configured to enable both a transmission and reception point (TRP)-level beam recovery process and a cell-level beam recovery process. For a beam recovery process, on condition that signal quality of a beam between a network device and a terminal device is poor, for example, in response to beam failure due to the beam being blocked by an obstacle (such as a human body or a vehicle), the terminal device can report, to the network device, a beam failure event that occurs, and optionally, the terminal device can recommend a new beam to the network device, so that quality of communication between the network device and the terminal device can be recovered as soon as possible. The TRP-level beam recovery process refers to a process in which the terminal device can monitor a TRP-level beam failure event and perform beam recovery. The cell-level beam recovery process refers to a process in which the terminal device can monitor a cell-level beam failure event and perform beam recovery. Therefore, on condition that the terminal device is configured to enable both a TRP-level beam recovery process and a cell-level beam recovery process, a type of a beam failure event that can be monitored by the terminal device includes a TRP-level beam failure event and/or a cell-level beam failure event. Only the terminal device configured with a beam recovery process can detect beam failure and perform a beam failure recovery (BFR). A beam failure event is contained in a beam recovery process, and thus for a cell configured with a beam recovery process, the terminal device can detect whether a beam failure event occurs in the cell. It needs to be noted that, one cell may be composed of one TRP or multiple TRPs. The TRP herein is a logical concept. One TRP may be one entity network site, such as a remote radio head (RRH) or a base station. Alternatively, one TRP may also be composed of multiple entity network sites.

To better understand embodiments of the disclosure, a network architecture applicable to embodiments of the disclosure is described below.

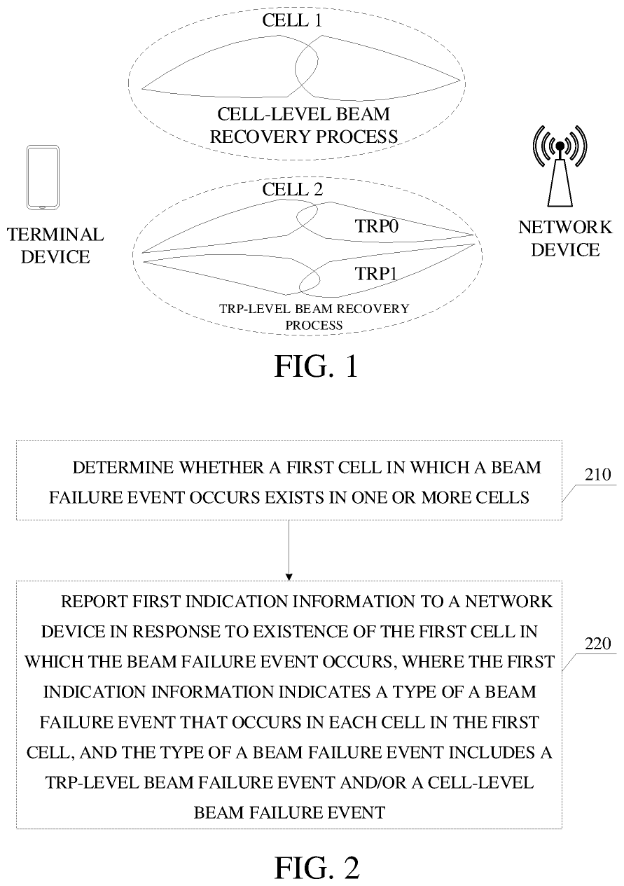

Refer to FIG. 1, where FIG. 1 is a schematic diagram of a communication network architecture provided in embodiments of the disclosure. As illustrated in FIG. 1, the communication network architecture includes a terminal device and a network device, where the terminal device establishes communication with the network device via a serving cell. The serving cell may include a cell 1 and a cell 2, and certainly may include two or more cells. In the embodiments of the disclosure, for example, the serving cell includes two cells, which is not limited. The cell 1 may belong to the network device, and the cell 2 may also belong to the network device. The cell 2 may also belong to another network device. The cell 1 is configured with a cell-level beam recovery process, and the cell 2 is configured with a TRP-level beam recovery process. The cell 2 is configured with two TRPs, i.e., TRP0 and TRP1. The cell 2 may also be configured with one TRP or more than two TRPs, which is not limited herein. It is understandable that the terminal device is configured with one or more cells, and a type of a beam failure event that occurs in the one or more cells includes a cell-level beam failure event and a TRP-level beam failure event. It needs to be noted that the TRP illustrated in FIG. 1 may be composed of multiple network devices. In embodiments of the disclosure, one TRP is composed of one network device, which is not limited herein.

It should be noted that, technical solutions of the disclosure are applicable to a 5th generation mobile communication (5G) communication system, also is applicable to a 4th generation (4G) communication system and a 3rd generation (3G) communication system, and also is applicable to various new future communication systems, such as a 6th generation (6G) communication system, a 7th generation (7G) communication system, and an in-vehicle short-distance communication system. The technical solutions of the disclosure also are applicable to different network architectures including, but not limited to, a relay network architecture, a dual-connectivity (DC) architecture, a vehicle-to-everything (V2X) communication architecture, an in-vehicle short-distance communication architecture, etc.

The core network in embodiments of the disclosure may be an evolved packet core (EPC) or a 5G core network, and may also be a new core network in a future communication system. The 5G core network consists of a set of devices, such as an access and mobility management function (AMF) implementing mobility management and other functions, a user plane function (UPF) providing functions such as data packet routing and forwarding and quality of service (QOS) management, and a session management function (SMF) providing functions such as session management, IP address allocation and management. The EPC may consist of a mobility management entity (MME) providing functions such as mobility management and gateway selection, a serving gateway (S-GW) providing functions such as data packet forwarding, and a PDN gateway (P-GW) providing functions such as terminal address allocation and rate control.

The network device involved in embodiments of the disclosure is an entity for transmission or reception of a signal at a network side. The network device can be used for performing mutual conversion between a received air frame and an internet protocol (IP) packet. The network device serves as a router between a terminal device and the rest of an access network, where the rest of the access network may include an IP network, etc. The network device may also coordinate management of attributes of air interfaces. For example, the network device may be an evolved NodeB (eNB) in long term evolution (LTE), a new radio (NR) controller, a gNB in a 5G system, a centralized unit, a new wireless base station, a remote radio module, a micro base station, a relay, a distributed unit, a TRP, a transmission point (TP), a G node in an in-vehicle short-distance communication system, or any other wireless access device, which is not limited thereto.

The network device in embodiments of the disclosure may include a base station (BS), and may also be referred to as base station device. The network device is an apparatus deployed in the wireless access network to provide wireless communication function. For example, a device providing a base station function in a second-generation (2G) network includes a base transceiver station (BTS). A device providing a base station function in a 3G network includes a NodeB. A device providing a base station function in a 4G network includes an eNB. In a wireless local area network (WLAN), a device providing a base station function is an access point (AP). In 5G NR, a device providing a base station function includes a gNB and an ng-eNB for continuing evolution. The gNB communicates with a terminal device through NR technology, the ng-eNB communicates with the terminal communicate through evolved universal terrestrial radio access (E-UTRA) technology, and both the gNB and the ng-eNB can be connected to a 5G core network. The base station in embodiments of the disclosure further includes a device providing a base station function in a future new communication system, and the like.

The base station controller (BSC) in embodiments of the disclosure is an apparatus for managing a base station, such as a BSC in a 2G network and a radio network controller (RNC) in a 3G network, and may also refer to an apparatus for controlling and managing a base station in a future new communication system.

The terminal device involved in embodiments of the disclosure is an entity for transmission or reception of a signal at a user side. The terminal device may be a device that provides voice and/or data connectivity to a user, for example, a device with a wireless connection function, such as a handheld device or a vehicle-mounted device. The terminal device may also be other processing devices coupled with a wireless modem. The terminal device can communicate with a radio access network (RAN). The terminal device may also be referred to as a wireless terminal, a subscriber unit, a subscriber station, a mobile station, a mobile platform, a remote station, an access point, a remote terminal, an access terminal, a user terminal, a user agent, a user device, a user equipment (UE), etc. The terminal device may be a mobile terminal, such as a mobile phone (or referred to as a “cellular” phone) and a computer equipped with a mobile terminal. For example, the terminal device may be a portable, pocket-sized, handheld, computer-built, or vehicle-mounted mobile device that exchanges language and/or data with the wireless access network. For example, the terminal device may also be a personal communication service (PCS) phone, a cordless phone, a session initiation protocol (SIP) phone, a wireless local loop (WLL) station, a personal digital assistant (PDA), or other devices. The common terminal device includes, for example, a mobile phone, a tablet computer, a notebook computer, a palmtop computer, a mobile internet device (MID), a vehicle, a roadside device, an aircraft, a T-node, and a wearable device such as a smart watch, a smart bracelet, and a pedometer, which is not limited in embodiments of the disclosure. A communication method and relevant devices provided in the disclosure are described in detail in the following.

A method and apparatus for information transmission are provided in embodiments of the disclosure. The method and apparatus for information transmission provided in embodiments of the disclosure are further described in detail below.

The embodiments of the disclosure may include two parts.

Firstly, a terminal device can determine whether a cell in which a beam failure event occurs exists in one or more cells configured for the terminal device, further determine a type of the beam failure event, and report the type of the beam failure event to a network device through first indication information. The type of the beam failure event may include a TRP-level beam failure event and/or a cell-level beam failure event. With the method, the terminal device can report a TRP-level beam failure event and/or a cell-level beam failure event to the network device.

Secondly, the terminal device can determine a type of a beam failure event that occurs in one or more cells, and report first information or second information to the network device according to the type of a beam failure event that occurs. The first information corresponds to a TRP-level beam failure event, and the second information corresponds to a cell-level beam failure event. With the method, the terminal device can report corresponding beam failure events through different information, respectively.

Refer to FIG. 2, where FIG. 2 is a schematic flowchart illustrating a method for information transmission provided in embodiments of the disclosure. The method for information transmission includes operations at 210 and 220. The method illustrated in FIG. 2 may be performed by a terminal device or a chip of the terminal device. The method is applied to a terminal device configured with one or more cells, and a type of a beam failure event that occurs in the one or more cells includes a cell-level beam failure event and a TRP-level beam failure event. The method may include the following in response to the terminal device performing the process illustrated in FIG. 2.

210, determine whether a first cell in which a beam failure event occurs exists in one or more cells.

Optionally, the one or more cells may be cells configured for the terminal device.

Optionally, the one or more cells may be serving cells configured for the terminal device.

The terminal device can determine whether the first cell in which the beam failure event occurs exists by performing beam detection on each of the one or more cells, where the first cell may include one cell or at least one cell.

Optionally, each of cells in the first cell is a cell in which a beam failure event occurs.

Optionally, in the one or more cells configured for the terminal device, for a cell configured with a cell-level beam recovery process, the terminal device can perform beam failure detection reference signal (BFD RS) detection. In response to signal quality of a BFD RS for the cell satisfying a preset condition, the terminal device can determine that a cell-level beam failure event occurs in the cell. Alternatively, in response to the signal quality of the BFD RS for the cell satisfying the preset condition and a new candidate beam being found, the terminal device can determine that a cell-level beam failure event occurs in the cell. The preset condition may be specified by a protocol or a standard.

Optionally, in the one or more cells configured for the terminal device, for a cell configured with a TRP-level beam recovery process, the terminal device can also detect a BFD RS for each TRP in the cell. In response to signal quality of a BFD RS for any one TRP in the cell satisfying the preset condition, the terminal device can determine that a TRP-level beam failure event occurs in the cell.

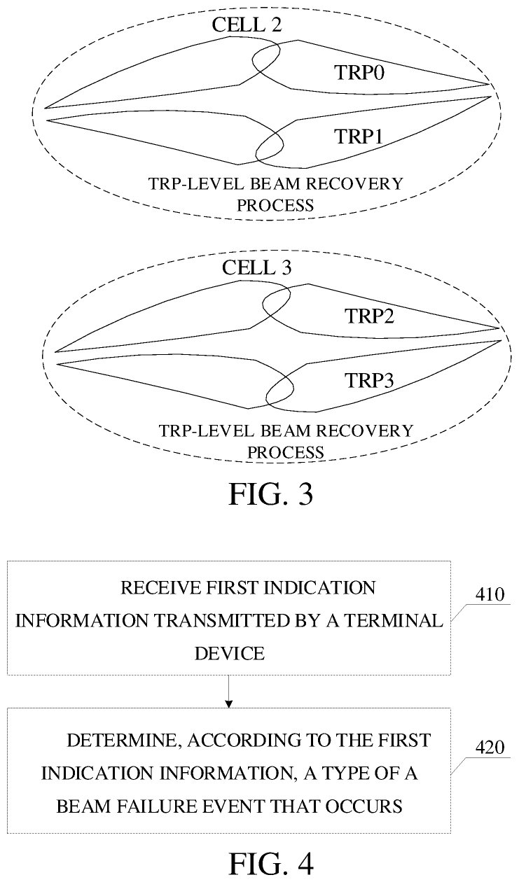

It needs to be noted that one cell may correspond to one or more beams, and one cell may correspond to one or more TRPs. One TRP may correspond to one or more beams. One beam corresponds to one BFD RS. For example, a BFD RS for a cell 1 in FIG. 1 is different from a BFD RS for a TRP1 in a cell 2, and a BFD RS for a TRP0 is also different from the BFD RS for the TRP1. For another example, FIG. 3 is a schematic diagram of two cells each configured with a TRP-level beam recovery process. The BFD RS for the TRP0 in the cell 2 is different from a BFD RS for a TRP2 in a cell 3, and the BFD RS for the TRP1 in the cell 2 is also different from a BFD RS for a TRP3 in the cell 3.

The terminal device can determine whether the first cell in which a beam failure event occurs exists in the one or more cells by detecting a BFD RS for each cell. On condition that the second cell is configured with a cell-level beam recovery process, the terminal device can determine that a cell-level beam failure event occurs in the second cell upon detecting that quality of a BFD RS for the second cell satisfies the preset condition. The second cell may be any one cell in the first cell.

On condition that the second cell is configured with a TRP-level beam recovery process, the terminal device can determine that a TRP-level beam failure event occurs in the second cell upon detecting that quality of a BFD RS for at least one TRP in the second cell satisfies the preset condition. The second cell may be any one cell in the first cell.

Optionally, on condition that the second cell is configured with both a TRP-level beam recovery process and a cell-level beam recovery process, the terminal device can determine that a cell-level beam failure event occurs in the second cell upon detecting that quality of each of BFD RSs for all TRPs in the second cell satisfies the preset condition.

220, report first indication information to a network device in response to existence of the first cell in which the beam failure event occurs. The first indication information indicates a type of a beam failure event that occurs in each cell in the first cell. The type of a beam failure event includes a TRP-level beam failure event and/or a cell-level beam failure event.

In a possible embodiment, the first indication information is reported through medium access control (MAC) control element (CE) signaling.

In a possible embodiment, the first indication information may indicate a situation of a beam failure event that occurs in each cell in the first cell. Specifically, the first indication information may contain one or more indication fields, and each of the one or more indication fields may correspond to a cell in which a beam failure event occurs. Each indication field may indicate a situation of a beam failure event that occurs in a corresponding cell. For example, a first indication field corresponds to the second cell, a second indication field corresponds to a third cell, and a third indication field corresponds to a fourth cell. Each of the second cell, the third cell, and the fourth cell is a cell in which a beam failure event occurs. The first indication field may indicate a situation of a beam failure event that occurs in the second cell, the second indication field may indicate a situation of a beam failure event that occurs in the third cell, and so on.

The following describes a case in which the first indication information indicates a situation of a beam failure event that occurs in each cell in at least one cell in which a beam failure event occurs, around a relationship between indication by the first indication field in the first indication information and indication to the second cell and the method for indicating the second cell by the first indication field.

In a possible embodiment, the first indication field in the first indication information may contain a first indication, where the first indication corresponds to the second cell. The first indication explicitly indicates that a type of a beam failure event that occurs in the second cell is a cell-level beam failure event or a TRP-level beam failure event. For example, in response to the first indication being 1, the first indication information indicates that the type of the beam failure event that occurs in the second cell is a cell-level beam failure event. Correspondingly, in response to the first indication being 0, the first indication information indicates that the type of the beam failure event that occurs in the second cell is a TRP-level beam failure event.

In a possible embodiment, the first indication information may indicate a type of a beam failure event that occurs in the second cell, and a TRP in which a beam failure event occurs in response to the type of a beam failure event is a TRP-level beam failure event. Specifically, the first indication field in the first indication information may contain a first indication and a second indication. The first indication indicates a type of a beam failure event that occurs. The second indication indicates a TRP in which a beam failure event occurs in response to the type is a TRP-level beam failure event. In the case where the first indication is a first bit value, a value of the second indication is an index of a TRP in which a beam failure event occurs. The value of the second indication is invalid in the case where the first indication is a second bit value. That is, regardless of the value of the second indication being 1 or 0, the first indication information indicates that a cell-level beam failure event occurs in the second cell. The first bit value and the second bit value may be configured or preset by the terminal device or an access network device.

For example, as illustrated in FIG. 1, for the cell 2, in the case where the first indication and the second indication are 01 in sequence from left to right (namely, the first indication is 0, and the second indication is 1), the first indication information indicates that the type of the beam failure event that occurs in the second cell is a TRP-level beam failure event and a TRP in which a beam failure event occurs is TRP1. For another example, in the case where the first indication and the second indication are 00 in sequence, the first indication information indicates that the type of the beam failure event that occurs in the second cell is a TRP-level beam failure event, and a TRP in which a beam failure event occurs is TRP0. That is to say, in the case where the first indication is 0, a value of the second indication is an index of a TRP in which a beam failure event occurs. The second indication is invalid in the case where the first indication is 1. That is, in the case where the first indication and the second indication are 10 in sequence or the first indication and the second indication are 11 in sequence, the first indication information indicates that the type of the beam failure event that occurs in the second cell is a cell-level beam failure event.

Optionally, when the number of TRPs configured in the second cell is greater than 2, the number of bits of the second indication can be adjusted accordingly. For example, when the number of TRPs configured in the second cell is 3, the number of bits of the second indication may be 2 bits, and when the number of TRPs configured in the second cell is 7, the number of bits of the second indication may be 3 bits.

In a possible embodiment, the first indication field in the first indication information may include a field occupying X bits. The field occupying the X bits corresponds to the second cell, each of the X bits occupied by the field is in a one-to-one correspondence with each TRP in the second cell, and X is an integer greater than 0. A value of each bit occupied by the field may indicate whether a beam failure event occurs in a corresponding TRP. For example, for the second cell, the field is 001, a first bit from left to right indicates TRP4, a second bit indicates TRP5, and a third bit indicates TRP6, and the field indicates that a TRP-level beam failure event occurs in each of the TRP4 and the TRP5. The TRP4, the TRP5, and the TRP6 all belong to the second cell.

Optionally, in the case where a value of the field occupying the X bits is a first preset value, the field occupying the X bits indicates that a cell-level beam failure event occurs in the second cell. For example, on condition that the field occupies 2 bits, the first preset value is set to 00 or 11. On condition that the field occupying the X bits is 00, the first indication field may indicate that the type of the beam failure event that occurs in the second cell is a cell-level beam failure event. Alternatively, on condition that the field occupying the X bits is 11, the first indication field may indicate that the type of the beam failure event that occurs in the second cell is a cell-level beam failure event.

Optionally, in the case where the value of the field occupying the X bits is a second preset value, the first indication information may indicate that a type of a beam failure event that occurs in the second cell is a cell-level beam failure event. The second preset value may be pre-configured. For example, on condition that the field occupying the X bits is 00, the first indication information may be configured to indicate that the type of the beam failure event that occurs in the second cell is a cell-level beam failure event.

It needs to be noted that, the relationship between indication by the first indication field and indication to the second cell and the method for indicating the second cell by the first indication field is also applicable to the second indication field and the third cell, the third indication field and the fourth cell, etc. In this way, the first indication information may indicate, through different indication fields, a situation of a beam failure event that occurs in each cell in at least one cell in which a beam failure event occurs.

With the embodiments of the disclosure, the terminal device can report the first indication information to the network device upon determining that the first cell in which a beam failure event occurs exists in the one or more cells. The first indication information may indicate a type of a beam failure event that occurs in each cell in the first cell. The first indication information may contain multiple indication fields, and each indication field may correspond to one cell. For example, the first indication field corresponds to the second cell, and the second indication field corresponds to the third cell.

The first indication field in the first indication information may explicitly indicate a type of a beam failure event that occurs in the second cell. The first indication field may not only indicate a type of a beam failure event that occurs in the second cell, but also indicate a TRP in which a beam failure event occurs in the second cell in the case where a TRP-level beam failure event occurs in the second cell.

Likewise, the second indication field in the first indication information may also explicitly indicate a type of a beam failure event that occurs in the third cell. The second indication field may not only indicate a type of a beam failure event that occurs in the third cell, but also indicate a TRP in which a beam failure event occurs in the third cell in the case where a TRP-level beam failure event occurs in the third cell. In this way, the first indication information may indicate a situation of each of beam failure events that occur in multiple cells in which the beam failure events occur.

With the method, on the one hand, the terminal device can report, to the network device, information indicating a TRP-level beam failure event, so that the network device can accurately position a TRP in which a beam failure event occurs, and the network device can take a specific measure to perform TRP-level beam recovery, thereby recovering normal communication connection. On the other hand, the terminal device can also report, to the network device, information indicating a cell-level beam failure event.

Refer to FIG. 4, where FIG. 4 is a schematic flowchart illustrating another method for information transmission provided in embodiments of the disclosure. The method for information transmission includes the following operations at 410 and 420. The method illustrated in FIG. 4 may be performed by a network device or a chip of the network device. The method may include the following in response to the network device performing the process illustrated in FIG. 4.

410, receive first indication information transmitted by a terminal device.

In a possible embodiment, the first indication information may be reported through MAC CE signaling, and the network device may receive the MAC CE signaling on a specific uplink channel.

420, determine, according to the first indication information, a type of a beam failure event that occurs.

In a possible embodiment, the first indication information may indicate a type of a beam failure event that occurs in each cell in the first cell, and the type of a beam failure event may include a TRP-level beam failure event and/or a cell-level beam failure event.

In a possible embodiment, the first indication information may indicate a situation of a beam failure event that occurs in each cell in the first cell. Specifically, the first indication information may contain one or more indication fields, and each of the one or more indication fields may correspond to a cell in which a beam failure event occurs. Each indication field may indicate a situation of a beam failure event that occurs in a corresponding cell. For example, a first indication field corresponds to the second cell, a second indication field corresponds to a third cell, and a third indication field corresponds to a fourth cell. Each of the second cell, the third cell, and the fourth cell is a cell in which a beam failure event occurs. The first indication field may indicate a situation of a beam failure event that occurs in the second cell, the second indication field may indicate a situation of a beam failure event that occurs in the third cell, and so on.

The relationship between indication by the first indication field and indication to the second cell and the method for indicating the second cell by the first indication field is also applicable to the second indication field and the third cell, the third indication field and the fourth cell, etc. In this way, the first indication information may indicate, through different indication fields, a situation of a beam failure event that occurs in each cell in the first cell.

The network device can determine, according to the first indication information, the first cell in which a beam failure event occurs, and a type of a beam failure event that occurs in each cell in the first cell. Furthermore, on condition that the network device determines that a type of a beam failure event that occurs in a certain beam failure (BF) cell is a TRP-level beam failure event, the network device can also determine a TRP in which a beam failure event occurs in the BF cell. Moreover, the network device can perform, as soon as possible, BFR on the cell in which a beam failure event occurs or on the TRP in which a beam failure event occurs, thereby recovering quality of communication between the terminal device and the network device as soon as possible.

With the embodiments of the disclosure, the network device can receive the first indication information, determine, according to the first indication information, a type of a beam failure event that occurs in each BF cell in the first cell in which a beam failure event occurs, and determine, in the case where a type of a beam failure event that occurs in a certain BF cell is a TRP-level beam failure event, a TRP in which a beam failure event occurs in the BF cell. With the method, the network device can obtain a TRP-level beam failure event and a cell-level beam failure event that are reported by the terminal device through the first indication information.

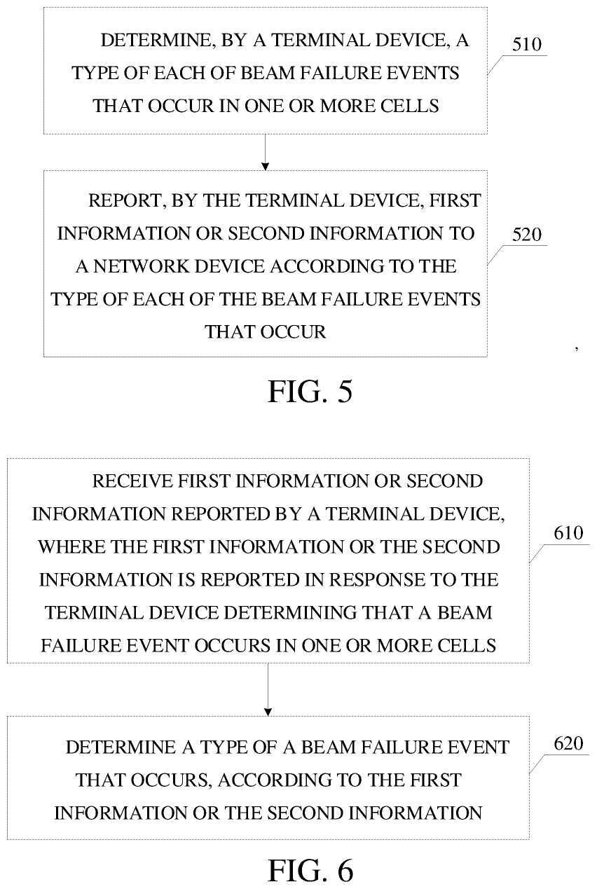

Refer to FIG. 5, where FIG. 5 is a schematic flowchart illustrating yet another method for information transmission provided in embodiments of the disclosure. The method for information transmission includes operations at 510 and 520. The method illustrated in FIG. 5 may be performed by a terminal device or a chip of the terminal device. The method is applied to a terminal device configured with one or more cells, and a type of each of beam failure events that occur in the one or more cells includes a cell-level beam failure event and a TRP-level beam failure event. The method may include the following in response to the terminal device performing the process illustrated in FIG. 5.

510, the terminal device determines a type of each of beam failure events that occur in one or more cells.

The terminal device can determine whether a cell in which a beam failure event occurs exists in each cell by detecting a BFD RS for each cell in the one or more cells configured for the terminal device, and determine a type of a beam failure event that occurs in response to existence of the cell.

Specifically, in the one or more cells configured for the terminal device, for a cell configured with a cell-level beam recovery process, the terminal device can detect a BFD RS for the cell. In response to signal quality of the BFD RS for the cell satisfying a preset condition, the terminal device can determine that a type of a beam failure event that occurs in the cell is a cell-level beam failure event. Alternatively, in response to the signal quality of the BFD RS for the cell satisfying the preset condition and a new candidate beam being found, the terminal device can determine that the type of a beam failure event that occurs in the cell is a cell-level beam failure event. Furthermore, in response to a type of each of beam failure events that occur in cells in the one or more cells being a cell-level beam failure event, the terminal device can determine that the type of each of the beam failure events that occur in the one or more cells is a cell-level beam failure event.

Optionally, in the one or more cells configured for the terminal device, for a cell configured with a TRP-level beam recovery process, the terminal device can also detect a BFD RS for each TRP in the cell. In response to signal quality of a BFD RS for any one TRP in the cell satisfying the preset condition, the terminal device can determine that a type of a beam failure event that occurs in the cell is a TRP-level beam failure event. Furthermore, in response to a type of each of beam failure events that occur in cells in the one or more cells being a TRP-level beam failure event, the terminal device can determine that the type of each of the beam failure events that occur in the one or more cells is a TRP-level beam failure event.

Optionally, on condition that the type of each of the beam failure events that occur in the cells in the one or more cells includes a cell-level beam failure event and a TRP-level beam failure event, the terminal device can determine that the type of each of the beam failure events that occur in the one or more cells includes not only a TRP-level beam failure event but also a cell-level beam failure event.

520, the terminal device reports first information or second information to a network device according to the type of each of the beam failure events that occur.

The first information may be first MAC CE signaling or a first scheduling request (SR). The second information may be second MAC CE signaling, a second SR, or a preamble sequence that is carried in a random access channel (RACH) resource.

The first information corresponds to a TRP-level beam failure event, and the second information corresponds to a cell-level beam failure event.

In a possible embodiment, the terminal device reports the first information in response to the type of each of the beam failure events that occur being a TRP-level beam failure event. That is, on condition that a type of each of beam failure events that occur in cells in the one or more cells is a TRP-level beam failure event, the terminal device can report the first information to the network device. The first information indicates to the network device a beam failure event that occurs.

In a possible embodiment, the terminal device reports the second information in response to the type of each of the beam failure events that occur being a cell-level beam failure event. That is, on condition that the type of each of the beam failure events that occur in the cells in the one or more cells is a cell-level beam failure event, the terminal device can report the second information to the network device. The second information indicates to the network device a beam failure event that occurs.

In a possible embodiment, the terminal device reports the first information in response to the type of each of the beam failure events that occur including not only a TRP-level beam failure event but also a cell-level beam failure event. That is to say, on condition that cells in which beam failure events occur in the one or more cells include a cell in which a TRP-level beam failure event occurs and a cell in which a cell-level beam failure event occurs, the terminal device can report the first information. The terminal device may be pre-configured to report the first information in this case.

Optionally, the terminal device reports the second information in response to the type of each of the beam failure events that occur including not only a TRP-level beam failure event but also a cell-level beam failure event. That is to say, on condition that the cells in which beam failure events occur in the one or more cells include a cell in which a TRP-level beam failure event occurs and a cell in which a cell-level beam failure event occurs, the terminal device can report the second information. Since a cell-level beam failure event may also occur in a cell with a relatively high priority in the one or more cells, the terminal device can preferentially report a type of a beam failure event that occurs in the cell with the relatively high priority, thereby ensuring stability of the entire communication system. The terminal device may also be pre-configured to report the second information in this case.

In a possible embodiment, the terminal device reports the first information, in response to the type of each of the beam failure events that occur including not only a TRP-level beam failure event but also a cell-level beam failure event, and a number of cells in which TRP-level beam failure events occur being greater than or equal to a number of cells in which cell-level beam failure events occur. Since the number of cells in which the TRP-level beam failure events occur is greater than the number of cells in which the cell-level beam failure events occur, the terminal device can report, through the first information, the cells in which the TRP-level beam failure events occur, so that more cells are preferentially subject to BFR.

Accordingly, the terminal device reports the second information, in response to the type of each of the beam failure events that occur including not only a TRP-level beam failure event but also a cell-level beam failure event, and the number of cells in which the TRP-level beam failure events occur being less than the number of cells in which the cell-level beam failure events occur. That is, since the number of cells in which the cell-level beam failure events occur is greater than the number of cells in which the TRP-level beam failure events occur, the terminal device can report, through the second information, the cells in which the cell-level beam failure events occur.

In a possible embodiment, the terminal device reports the first information, in response to the type of each of the beam failure events that occur including not only a TRP-level beam failure event but also a cell-level beam failure event, and a smallest index of a cell in cells in which TRP-level beam failure events occur being smaller than a smallest index of a cell in cells in which cell-level beam failure events occur. That is to say, when the network device indexes each cell in the one or more cells, the network device can arrange the cells according to a descending order of priorities of the cells. On condition that the smallest index of the cell in the cells in which the TRP-level beam failure events occur is smaller than the smallest index of the cell in the cells in which the cell-level beam failure events occur, a priority of the cell in which a TRP-level beam failure event occurs is higher than a priority of the cell in which a cell-level beam failure event occurs. Therefore, the terminal device needs to report the first information.

Accordingly, the terminal device reports the second information, in response to the type of each of the beam failure events that occur including not only a TRP-level beam failure event but also a cell-level beam failure event, and the smallest index of the cell in the cells in which the TRP-level beam failure events occur being greater than or equal to the smallest index of the cell in the cells in which the cell-level beam failure events occur. That is to say, the priority of the cell in which a TRP-level beam failure event occurs is lower than the priority of the cell in which a cell-level beam failure event occurs. Therefore, the terminal device needs to report the second information.

In a possible embodiment, the terminal device reports the second information, in response to the type of each of the beam failure events that occur including not only a TRP-level beam failure event but also a cell-level beam failure event, and a smallest index of a cell in cells in which TRP-level beam failure events occur being smaller than a smallest index of a cell in cells in which cell-level beam failure events occur.

Accordingly, the terminal device reports the first information, in response to the type of each of the beam failure events that occur including not only a TRP-level beam failure event but also a cell-level beam failure event, and the smallest index of the cell in the cells in which the TRP-level beam failure events occur being greater than or equal to the smallest index of the cell in the cells in which the cell-level beam failure events occur.

In a possible embodiment, the terminal device reports the second information, in response to the type of each of the beam failure events that occur including not only a TRP-level beam failure event but also a cell-level beam failure event, and a cell-level beam failure event also occurring in a primary cell. Since the primary cell has a relatively high importance in the one or more cells, a beam failure event occurring in the primary cell is likely to result in that a beam failure event also occurs in another cell. Therefore, the terminal device needs to report the second information to the network device, and the network device preferentially processes the cell-level beam failure event that occurs in the primary cell.

In a possible embodiment, the terminal device reports the second information, in response to the type of each of the beam failure events that occur including not only a TRP-level beam failure event but also a cell-level beam failure event, and a TRP-level beam failure event also occurring in a primary cell. Since the primary cell has a relatively high importance in the one or more cells, a beam failure event occurring in the primary cell is likely to result in that a beam failure event also occurs in another cell. Therefore, the terminal device needs to report the second information to the network device, and the network device preferentially processes the cell-level beam failure event that occurs in the primary cell.

It needs to be noted that, the foregoing eight possible embodiments are in a parallel relationship, that is, the terminal device can select one of the possible embodiments to determine whether a beam failure event is reported through the first information or the second information.

In the embodiments of the disclosure, subsequent to determination of the type of each of the beam failure events that occur in the one or more cells, the terminal device can finally determine whether a beam failure event that occurs is reported to the network device through the first information or the second information by analyzing a cell in which a TRP-level beam failure event occurs and/or a cell in which a cell-level beam failure event occurs. The first information may be first MAC CE signaling or a first SR. The first information corresponds to a TRP-level beam failure event. The second information may be second MAC CE signaling, a second SR, or a preamble sequence that is carried in an RACH resource. The second information corresponds to a cell-level beam failure event. With the method, the terminal device can report corresponding beam failure events through different information, respectively.

Refer to FIG. 6, where FIG. 6 is a schematic flowchart illustrating yet another method for information transmission provided in embodiments of the disclosure. The method for information transmission includes the following operations at 610 and 620. The method illustrated in FIG. 6 may be performed by a network device or a chip of the network device. The method may include the following in response to the network device performing the process illustrated in FIG. 6.

610, receive first information or second information reported by a terminal device, where the first information or the second information is reported in response to the terminal device determining that a beam failure event occurs in one or more cells.

The first information may be first MAC CE signaling or a first SR. The second information may be second MAC CE signaling, a second SR, or a preamble sequence that is carried in an RACH resource.

The terminal device reporting the first information or the second information has been described in detail in the embodiment corresponding to FIG. 5, which will not be repeated herein.

620, determine a type of a beam failure event that occurs, according to the first information or the second information.

The network device determines, according to the first information, that a type of a beam failure event that occurs in the one or more cells, is a TRP-level beam failure event. The network device determines, according to the second information, that the type of a beam failure event that occurs in the one or more cells is a cell-level beam failure event.

With the method, the network device can receive the first information or the second information transmitted by the terminal device, and determine whether a cell in which a beam failure event occurs exists in the one or more cells configured for the terminal device. In this case, the network device can determine different types of beam failure events according to different information.

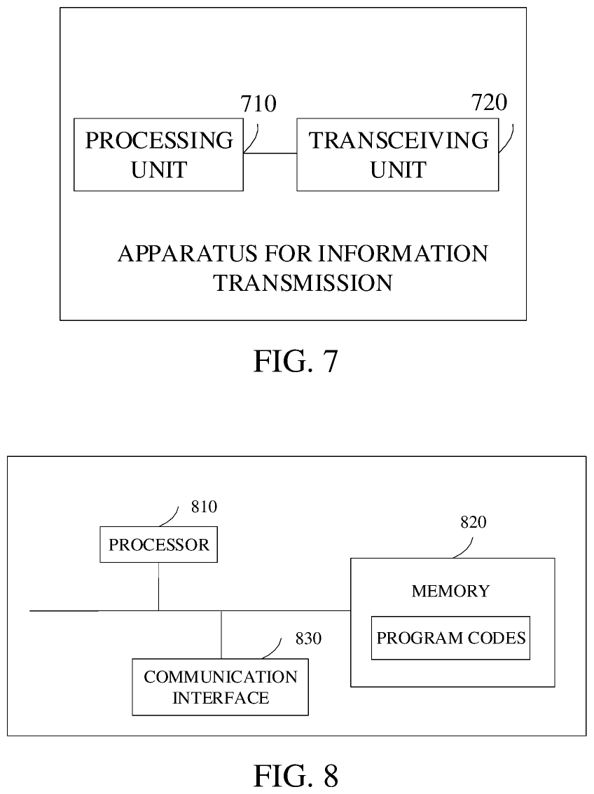

Refer to FIG. 7, where FIG. 7 is a schematic diagram of units of an apparatus for information transmission provided in embodiments of the disclosure. The apparatus for information transmission illustrated in FIG. 7 may be configured to perform part or all of functions in the method embodiments described in FIG. 2, FIG. 4, FIG. 5, and FIG. 6. The apparatus may be a terminal device, an apparatus in the terminal device, or an apparatus that can be matched with the terminal device for use.

A logical structure of the apparatus may include a processing unit 710 and a transceiving unit 720. The processing unit 710 is configured to determine whether a first cell in which a beam failure event occurs exists in one or more cells. The transceiving unit 720 is configured to report first indication information to a network device in response to existence of the first cell in which the beam failure event occurs. The first indication information indicates a type of a beam failure event that occurs in each cell in the first cell.

In a possible embodiment, the first indication information is reported through MAC CE signaling and contains at least one indication field. A first indication field in the at least one indication field corresponds to a second cell, and the second cell is any one cell in the first cell.

In a possible embodiment, the first indication information indicates the type of a beam failure event that occurs in each cell in the first cell.

In a possible embodiment, a first indication field in the first indication information contains a first indication, wherein the first indication explicitly indicates a type of a beam failure event that occurs in a second cell.

In a possible embodiment, a first indication field in the first indication information indicates a type of a beam failure event that occurs, and a TRP in which a beam failure event occurs in response to the type is a TRP-level beam failure event, wherein the TRP belongs to a second cell.

In a possible embodiment, the first indication field in the first indication information contains a first indication and a second indication. The first indication indicates a type of a beam failure event that occurs. The second indication indicates a TRP in which a beam failure event occurs in response to the type is a TRP-level beam failure event.

In a possible embodiment, the first indication field in the first indication information comprises a field occupying X bits, wherein each of the X bits corresponds to one TRP. A value of each of the X bits indicates whether a beam failure event occurs in a corresponding TRP.

In a possible embodiment, in response to the field occupying the X bits being a preset bit value, the first indication information indicates that a type of a beam failure event that occurs in the second cell is a cell-level beam failure event.

The apparatus further includes a processing unit 710 and a transceiving unit 720 when the apparatus is applied to a terminal device. The processing unit 710 is configured to determine a type of each of beam failure events that occur in one or more cells. The transceiving unit 720 is configured to report first information or second information to a network device according to the type of each of the beam failure events that occur.

In a possible embodiment, the first information is first MAC CE signaling or a first SR. The second information is second MAC CE signaling, a second SR, or a preamble sequence that is carried in an RACH resource.

In a possible embodiment, the first information corresponds to a TRP-level beam failure event, and the second information corresponds to a cell-level beam failure event.

In a possible embodiment, the terminal device reports the first information in response to the type of each of the beam failure events that occur being a TRP-level beam failure event. Alternatively, the terminal device reports the second information in response to the type of each of the beam failure events that occur being a cell-level beam failure event.

In a possible embodiment, the terminal device reports the first information in response to the type of each of the beam failure events that occur comprising not only a TRP-level beam failure event but also a cell-level beam failure event. Alternatively, the terminal device reports the second information in response to the type of each of the beam failure events that occur comprising not only a TRP-level beam failure event but also a cell-level beam failure event.

In a possible embodiment, the terminal device reports the first information, in response to the type of each of the beam failure events that occur comprising not only a TRP-level beam failure event but also a cell-level beam failure event, and a number of cells in which TRP-level beam failure events occur being greater than or equal to a number of cells in which cell-level beam failure events occur. Alternatively, the terminal device reports the second information, in response to the type of each of the beam failure events that occur comprising not only a TRP-level beam failure event but also a cell-level beam failure event, and the number of cells in which the TRP-level beam failure events occur being less than the number of cells in which the cell-level beam failure events occur.

In a possible embodiment, the terminal device reports the first information, in response to the type of each of the beam failure events that occur comprising not only a TRP-level beam failure event but also a cell-level beam failure event, and a smallest index of a cell in cells in which TRP-level beam failure events occur being smaller than a smallest index of a cell in cells in which cell-level beam failure events occur. Alternatively, the terminal device reports the second information, in response to the type of each of the beam failure events that occur comprising not only a TRP-level beam failure event but also a cell-level beam failure event, and the smallest index of the cell in the cells in which the TRP-level beam failure events occur being greater than or equal to the smallest index of the cell in the cells in which the cell-level beam failure events occur.

In a possible embodiment, the terminal device reports the second information, in response to the type of each of the beam failure events that occur comprising not only a TRP-level beam failure event but also a cell-level beam failure event, and a smallest index of a cell in cells in which TRP-level beam failure events occur being smaller than a smallest index of a cell in cells in which cell-level beam failure events occur. Alternatively, the terminal device reports the first information, in response to the type of each of the beam failure events that occur comprising not only a TRP-level beam failure event but also a cell-level beam failure event, and the smallest index of the cell in the cells in which the TRP-level beam failure events occur being greater than or equal to the smallest index of the cell in the cells in which the cell-level beam failure events occur.

In a possible embodiment, the terminal device reports the second information, in response to the type of each of the beam failure events that occur comprising not only a TRP-level beam failure event but also a cell-level beam failure event, and a cell-level beam failure event also occurring in a primary cell.

In a possible embodiment, the terminal device reports the first information, in response to the type of each of the beam failure events that occur comprising not only a TRP-level beam failure event but also a cell-level beam failure event, and a TRP-level beam failure event also occurring in a primary cell.

Refer to FIG. 8, where FIG. 8 is a simplified schematic structural view of an apparatus for information transmission provided in embodiments of the disclosure. The apparatus includes a processor 810, a memory 820, and a communication interface 830. The processor 810, the memory 820, and the communication interface 830 are connected to each other via one or more communication buses. The apparatus for information transmission may be a chip, a chip module, etc.

The processor 810 is configured to support the apparatus for information transmission to perform functions corresponding to the methods in FIG. 2, FIG. 4, FIG. 5, and FIG. 6. It can be understood that in embodiments of the disclosure, the processor 810 may be a central processing unit (CPU). The processor may also be other general-purpose processors, a digital signal processor (DSP), an application specific integrated circuit (ASIC), a field programmable gate array (FPGA), other programmable logic devices, discrete gates or transistor logic devices, or discrete hardware components. The general-purpose processor may be a microprocessor, or the processor may be any conventional processor or the like.

The memory 820 is configured to store program codes. The memory 820 in embodiments of the disclosure may be a volatile memory or a non-volatile memory, or may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory can be a random access memory (RAM) that acts as an external cache. By way of example but not limitation, many forms of RAM are available, such as a static random access memory (SRAM), a dynamic random access memory (DRAM), a synchronous dynamic random access memory (SDRAM), an enhanced SDRAM (ESDRAM), a synclink dynamic random access memory (SLDRAM), and a direct rambus random access memory (DRRAM).

The communication interface 830 is configured to receive and transmit data, information, messages, and the like, and may also be described as a transceiver, a transceiving circuit, and the like.

In embodiments of the disclosure, the processor 810 is configured to invoke the program codes stored in the memory 820 to perform the following, when the apparatus for information transmission is applied to the terminal device. The processor 810 is configured to invoke the program codes stored in the memory 820 to determine whether a first cell in which a beam failure event occurs exists in one or more cells: control the communication interface 830 to report first indication information to a network device in response to existence of the first cell in which the beam failure event occurs. The first indication information indicates a type of a beam failure event that occurs in each cell in the first cell.

In a possible embodiment, the first indication information is reported through MAC CE signaling and contains at least one indication field. A first indication field in the at least one indication field corresponds to a second cell, and the second cell is any one cell in the first cell.

In a possible embodiment, the first indication information indicates the type of a beam failure event that occurs in each cell in the first cell.

In a possible embodiment, a first indication field in the first indication information contains a first indication, wherein the first indication explicitly indicates a type of a beam failure event that occurs in a second cell.

In a possible embodiment, a first indication field in the first indication information indicates a type of a beam failure event that occurs, and a TRP in which a beam failure event occurs in response to the type is a TRP-level beam failure event, wherein the TRP belongs to a second cell.

In a possible embodiment, the first indication field in the first indication information contains a first indication and a second indication. The first indication indicates a type of a beam failure event that occurs. The second indication indicates a TRP in which a beam failure event occurs in response to the type is a TRP-level beam failure event.

In a possible embodiment, the first indication field in the first indication information comprises a field occupying X bits, wherein each of the X bits corresponds to one TRP. A value of each of the X bits indicates whether a beam failure event occurs in a corresponding TRP.

In a possible embodiment, in response to the field occupying the X bits being a preset bit value, the first indication information indicates that a type of a beam failure event that occurs in the second cell is a cell-level beam failure event.

The apparatus further includes a processor 810 when the apparatus is applied to a terminal device. The processor 810 is configured to invoke the program codes stored in the memory 820 to determine a type of each of beam failure events that occur in one or more cells: control the communication interface 830 to report first information or second information to a network device according to the type of each of the beam failure events that occur.

In a possible embodiment, the first information is first MAC CE signaling or a first SR. The second information is second MAC CE signaling, a second SR, or a preamble sequence that is carried in an RACH resource.

In a possible embodiment, the first information corresponds to a TRP-level beam failure event, and the second information corresponds to a cell-level beam failure event.

In a possible embodiment, the terminal device reports the first information in response to the type of each of the beam failure events that occur being a TRP-level beam failure event. Alternatively, the terminal device reports the second information in response to the type of each of the beam failure events that occur being a cell-level beam failure event.

In a possible embodiment, the terminal device reports the first information in response to the type of each of the beam failure events that occur comprising not only a TRP-level beam failure event but also a cell-level beam failure event. Alternatively, the terminal device reports the second information in response to the type of each of the beam failure events that occur comprising not only a TRP-level beam failure event but also a cell-level beam failure event.

In a possible embodiment, the terminal device reports the first information, in response to the type of each of the beam failure events that occur comprising not only a TRP-level beam failure event but also a cell-level beam failure event, and a number of cells in which TRP-level beam failure events occur being greater than or equal to a number of cells in which cell-level beam failure events occur. Alternatively, the terminal device reports the second information, in response to the type of each of the beam failure events that occur comprising not only a TRP-level beam failure event but also a cell-level beam failure event, and the number of cells in which the TRP-level beam failure events occur being less than the number of cells in which the cell-level beam failure events occur.

In a possible embodiment, the terminal device reports the first information, in response to the type of each of the beam failure events that occur comprising not only a TRP-level beam failure event but also a cell-level beam failure event, and a smallest index of a cell in cells in which TRP-level beam failure events occur being smaller than a smallest index of a cell in cells in which cell-level beam failure events occur. Alternatively, the terminal device reports the second information, in response to the type of each of the beam failure events that occur comprising not only a TRP-level beam failure event but also a cell-level beam failure event, and the smallest index of the cell in the cells in which the TRP-level beam failure events occur being greater than or equal to the smallest index of the cell in the cells in which the cell-level beam failure events occur.

In a possible embodiment, the terminal device reports the second information, in response to the type of each of the beam failure events that occur comprising not only a TRP-level beam failure event but also a cell-level beam failure event, and a smallest index of a cell in cells in which TRP-level beam failure events occur being smaller than a smallest index of a cell in cells in which cell-level beam failure events occur. Alternatively, the terminal device reports the first information, in response to the type of each of the beam failure events that occur comprising not only a TRP-level beam failure event but also a cell-level beam failure event, and the smallest index of the cell in the cells in which the TRP-level beam failure events occur being greater than or equal to the smallest index of the cell in the cells in which the cell-level beam failure events occur.

In a possible embodiment, the terminal device reports the second information, in response to the type of each of the beam failure events that occur comprising not only a TRP-level beam failure event but also a cell-level beam failure event, and a cell-level beam failure event also occurring in a primary cell.

In a possible embodiment, the terminal device reports the first information, in response to the type of each of the beam failure events that occur comprising not only a TRP-level beam failure event but also a cell-level beam failure event, and a TRP-level beam failure event also occurring in a primary cell.

Each module/unit included in each apparatus or product described in the foregoing embodiments may be a software module/unit, a hardware module/unit, a software module/unit, or a hardware module/unit. For example, with regard to various apparatuses and products applied to or integrated in a chip, various modules/units contained therein can all be realized by means of hardware, such as a circuit, or at least some of the modules/units can be realized by means of a software program running on a processor integrated inside the chip, and the remaining (if any) part of the modules/units can be realized by means of hardware, such as a circuit. With regard to various apparatuses and products applied to or integrated in a chip module, various modules/units contained therein can all be realized by means of hardware, such as a circuit. Different modules/units may be located in the same component (e.g., chip, circuit module, etc.) of a chip module or in different components. Alternatively, at least part of the modules/units may be implemented using a software program running on a processor integrated within the chip module. The rest (if any) of the modules/units may be implemented by hardware such as circuits. With regard to various apparatuses and products applied to or integrated in a terminal device, various modules/units contained therein can all be realized by means of hardware, such as a circuit. Different modules/units may be located in the same component (for example, a chip, a circuit module, and so on) or different components in the terminal device. Alternatively, at least some of the modules/units may be implemented by using a software program running on a processor integrated inside the terminal device. The rest (if any) of the modules/units may be implemented by hardware such as circuits.

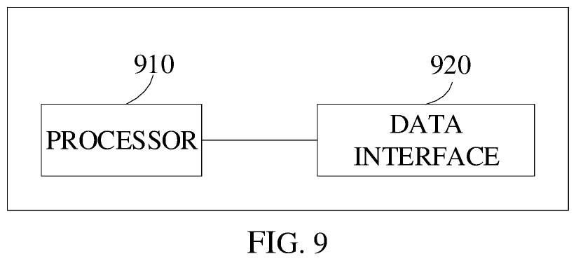

Refer to FIG. 9, where FIG. 9 is a simplified schematic diagram of a chip of an apparatus for information transmission provided in embodiments of the disclosure. The chip includes a processor 910 and a data interface 920. The chip may be configured to perform corresponding functions in the method described in FIG. 2, FIG. 4, FIG. 5, and FIG. 6. The chip may be contained in the apparatus for information transmission illustrated in FIG. 8. The chip may also be contained in a chip module.

It needs to be noted that, in the foregoing embodiments, the illustration of each embodiment has its own emphasis. For the parts not described in detail in a certain embodiment, reference may be made to related descriptions in other embodiments.

The operations of the methods of the embodiments of the disclosure can be adjusted, combined, and deleted according to actual needs.

The modules or units of the processing devices of the embodiments of the disclosure can be combined, divided, and deleted according to actual needs.

All or part of the above embodiments can be implemented through software, hardware, firmware, or any other combination thereof. When implemented by software, all or part of the above functions can be implemented in the form of a computer program product. The computer program product includes one or more computer instructions. When the computer program instructions are loaded and executed on a computer, all or part of the processes or functions of the embodiments of the disclosure are performed. The computer can be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instruction can be transmitted from one web site, computer, server, or data center to another web site, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer-accessible usable-medium or a data storage device such as a server, a data center, or the like which is integrated with one or more usable media. The usable medium can be a magnetic medium (such as a soft disc, a storage disc, or a magnetic tape), an optical medium (such as a digital video disc (DVD)), or a semiconductor medium (such as a solid state disk (SSD)), etc.

Finally, it should be noted that the foregoing embodiments are merely intended for describing the technical solutions of the disclosure rather than limiting the disclosure. Although the disclosure is described in detail with reference to the foregoing embodiments, those of ordinary skill in the art should understand that they may still make modifications to the technical solutions described in the foregoing embodiments, or make equivalent replacements to some or all technical features thereof. These modifications or replacements do not make the essence of the corresponding technical solutions depart from the scope of the technical solutions of the embodiments of the disclosure.

1. A method for information transmission, comprising:
determining whether a first cell in which a beam failure event occurs exists in one or more cells; and
reporting first indication information to a network device in response to existence of the first cell in which the beam failure event occurs, the first indication information indicating a type of a beam failure event that occurs in each cell in the first cell, and the type of a beam failure event comprising a transmission and reception point (TRP)-level beam failure event and/or a cell-level beam failure event.

2. The method of claim 1, wherein the first indication information is reported through medium access control (MAC) control element (CE) signaling and contains at least one indication field, a first indication field in the at least one indication field corresponds to a second cell, and the second cell is any one cell in the first cell.

3. The method of claim 1, wherein
the first indication information indicates the type of a beam failure event that occurs in each cell in the first cell.

4. The method of claim 1, wherein
a first indication field in the first indication information contains a first indication, wherein the first indication explicitly indicates a type of a beam failure event that occurs in a second cell.

5. The method of claim 1, wherein
a first indication field in the first indication information indicates a type of a beam failure event that occurs, and a TRP in which a beam failure event occurs in response to the type is a TRP-level beam failure event, wherein the TRP belongs to a second cell.

6. The method of claim 5, wherein
the first indication field in the first indication information contains a first indication and a second indication;
the first indication indicates a type of a beam failure event that occurs; and
the second indication indicates a TRP in which a beam failure event occurs in response to the type is a TRP-level beam failure event.

7. The method of claim 5, wherein
the first indication field in the first indication information comprises a field occupying X bits, wherein each of the X bits corresponds to one TRP; and
a value of each of the X bits indicates whether a beam failure event occurs in a corresponding TRP.

8. The method of claim 7, wherein in response to the field occupying the X bits being a preset bit value, the first indication information indicates that a type of a beam failure event that occurs in the second cell is a cell-level beam failure event.

9. The method of claim 1, further comprising:
determining, by a terminal device, a type of each of beam failure events that occur in one or more cells; and
reporting, by the terminal device, first information or second information to a network device according to the type of each of the beam failure events that occur.

10. The method of claim 9, wherein the first information is first medium access control (MAC) control element (CE) signaling or a first scheduling request (SR), and the second information is second MAC CE signaling, a second SR, or a preamble sequence that is carried in a random access channel (RACH) resource.

11. The method of claim 9, wherein the first information corresponds to a TRP-level beam failure event, and the second information corresponds to a cell-level beam failure event.

12. The method of claim 9, wherein
the terminal device reports the first information in response to the type of each of the beam failure events that occur being a TRP-level beam failure event; or
the terminal device reports the second information in response to the type of each of the beam failure events that occur being a cell-level beam failure event.

13. The method of claim 9, wherein,
the terminal device reports the first information in response to the type of each of the beam failure events that occur comprising not only a TRP-level beam failure event but also a cell-level beam failure event: or,
the terminal device reports the second information in response to the type of each of the beam failure events that occur comprising not only a TRP-level beam failure event but also a cell-level beam failure event.

14. The method of claim 9, wherein,
the terminal device reports the first information, in response to the type of each of the beam failure events that occur comprising not only a TRP-level beam failure event but also a cell-level beam failure event, and a number of cells in which TRP-level beam failure events occur being greater than or equal to a number of cells in which cell-level beam failure events occur: or
the terminal device reports the second information, in response to the type of each of the beam failure events that occur comprising not only a TRP-level beam failure event but also a cell-level beam failure event, and the number of cells in which the TRP-level beam failure events occur being less than the number of cells in which the cell-level beam failure events occur.

15. The method of claim 9, wherein,
the terminal device reports the first information, in response to the type of each of the beam failure events that occur comprising not only a TRP-level beam failure event but also a cell-level beam failure event, and a smallest index of a cell in cells in which TRP-level beam failure events occur being smaller than a smallest index of a cell in cells in which cell-level beam failure events occur: or
the terminal device reports the second information, in response to the type of each of the beam failure events that occur comprising not only a TRP-level beam failure event but also a cell-level beam failure event, and the smallest index of the cell in the cells in which the TRP-level beam failure events occur being greater than or equal to the smallest index of the cell in the cells in which the cell-level beam failure events occur.

16. The method of claim 9, wherein
the terminal device reports the second information, in response to the type of each of the beam failure events that occur comprising not only a TRP-level beam failure event but also a cell-level beam failure event, and a beam failure event also occurring in a primary cell.

17. (canceled)

18. An apparatus for information transmission, comprising a processor and a memory, wherein the memory is configured to store a computer program, the computer program comprises program instructions, and the processor is configured to invoke the program instructions to perform;
determining whether a first cell in which a beam failure event occurs exists in one or more cells; and
reporting first indication information to a network device in response to existence of the first cell in which the beam failure event occurs, the first indication information indicating a type of a beam failure event that occurs in each cell in the first cell, and the type of a beam failure event comprising a transmission and reception point (TRP)-level beam failure event and/or a cell-level beam failure event.

19. A non-transitory computer-readable storage medium storing one or more instructions, wherein a processor is configured to load the one or more instructions and perform;
determining whether a first cell in which a beam failure event occurs exists in one or more cells; and
reporting first indication information to a network device in response to existence of the first cell in which the beam failure event occurs, the first indication information indicating a type of a beam failure event that occurs in each cell in the first cell, and the type of a beam failure event comprising a transmission and reception point (TRP)-level beam failure event and/or a cell-level beam failure event.

20-21. (canceled)

22. The apparatus for information transmission of claim 18, wherein
a first indication field in the first indication information contains a first indication, wherein the first indication explicitly indicates a type of a beam failure event that occurs in a second cell.

23. The non-transitory computer-readable storage medium of claim 19, wherein
a first indication field in the first indication information indicates a type of a beam failure event that occurs, and a TRP in which a beam failure event occurs in response to the type is a TRP-level beam failure event, wherein the TRP belongs to a second cell.
